(19) United States
(12) Patent Application Publication
(10) Pub. No.: US 2024/0014444 A1
(43) Pub. Date: Jan. 11, 2024

(54) NON-AQUEOUS ELECTROLYTE SOLUTION AND LITHIUM BATTERY

(71) Applicant: ZHANGJIAGANG GUOTAI-HUARONG NEW CHEMICAL MATERIALS CO., LTD, Suzhou, Jiangsu (CN)

(72) Inventors: Xiaoqin Chen, Suzhou, Jiangsu (CN); Chaolun Gan, Suzhou, Jiangsu (CN); Erbo Shi, Suzhou, Jiangsu (CN); Li Zhang, Suzhou, Jiangsu (CN); Mingyao Gu, Suzhou, Jiangsu (CN); Cao Sun, Suzhou, Jiangsu (CN)

(21) Appl. No.: 18/254,302

(22) PCT Filed: Nov. 11, 2021
(86) PCT No.: PCT/CN2021/130047

§ 371 Date: May 24, 2023

(30) Foreign Application Priority Data
Nov. 25, 2020 (CN) 202011334924.7

(51) Int. Cl. H01M 10/0567; H01M 10/0525

(52) U.S. Cl. CPC H01M 10/0567; H01M 10/0525

(57) ABSTRACT

Embodiments described herein are directed to a non-aqueous electrolyte solution that may include a lithium salt, an organic solvent, and additives. The additives may include an additive A and an additive B. Additive A may be one or more of the substances represented by the structural general formula

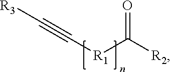

where 0≤n≤3, R₁ may be selected from alkylene, alkyleneoxy, fluoroalkylene, fluoroalkyleneoxy, alkenylene or fluoroalkenylene, and R₂ and R₃ may be independently selected from hydrogen, phenyl, alkynyl, alkynyloxy, alkyl, alkoxy, fluoroalkyl, fluoroalkoxy, alkenyl or fluoroalkenyl. Additive B may be a boron-containing lithium salt.

### CROSS-REFERENCE TO RELATED APPLICATIONS

This application is the U.S. National Stage of PCT/CN2021/130047 filed on Nov. 11, 2021, which claims priority to Chinese Patent Application 202011334924.7 filed on Nov. 25, 2020, the entire content of both are incorporated herein by reference in their entirety.

### FIELD

The present disclosure belongs to the lithium-ion battery field, in particular to a non-aqueous electrolyte solution and a lithium-ion battery.

### BACKGROUND

With the emergence of new consumption fields such as mobile phones, tablet computers, smart wearables, etc., lithium-ion batteries have shown great advantages due to their high energy density and long cycle life. Sulfonyl compounds are usually used in the field of electrolyte solutions in the form of small organic molecules, as solvent additives for non-aqueous electrolyte solutions of lithium-ion batteries, using the electrode film-forming properties of sulfonyl groups to form a stable SEI film/protective film on the electrode surface, thereby suppressing gas generation, and improving the high-temperature storage performance, cycle performance, life characteristics, etc. of the batteries. In the electrolyte solution, lithium salts containing sulfonyl groups are also widely used, especially sulfonimide salts. From EU REACH regulations, for SVHC substances contained in articles, if the substance is present in those articles above a concentration of 0.1% weight by weight and the total amount of the articles produced or imported exceeds 1 tonne/year, the producer or importer of the articles shall notify the European Chemicals Agency. Within 6 months after the substance is included in the REACH authorization candidate list (i.e., SVHC list), the enterprise must submit the ECHA notification. Our products are exported in the form of electrolyte solutions (mixture) and do not need to be notified (notification is only required when exporting as consumer goods, such as: batteries), and PS (1,3-propanesultone) was updated to the SVHC (Substances of Very High Concern) list on Dec. 17, 2015, it is a hazardous substance, but it is not in the restriction and authorization list, and has been included in the candidate list for authorization (that is to say, it may be officially included in the authorization list in the future). If it is officially included in the authorization list in the future, the importers need authorization for their use, and if the authorization is denied, the substance will be banned at a certain time. As the SVHC list gets wider, many sulfur-containing compounds are likely to be restricted later. Therefore, there is a need to find sulfur-free additives that can replace sulfur-containing compounds and improve the high-temperature storage performance and cycle performance of electrolyte solutions.

### BRIEF SUMMARY

The technical problem to be solved by the present disclosure is to provide a new non-aqueous electrolyte solution and lithium battery capable of ensuring high temperature storage performance and cycle performance.

To solve the above technical problems, the present disclosure employs the following technical solution:

One aspect of the present disclosure provides a non-aqueous electrolyte solution comprising a lithium salt, an organic solvent and additives, and the additives comprise an additive A and an additive B,
the additive A is one or more of the substances represented by the structural general formula (1), the structural general formula (1) of the additive A is:

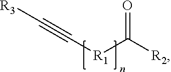

and R₁ may be selected from alkylene, alkyleneoxy, fluoroalkylene, fluoroalkyleneoxy, alkenylene or fluoroalkenylene, and R₂ and R₃ may be independently selected from hydrogen, phenyl, alkynyl, alkynyloxy, alkyl, alkoxy, fluoroalkyl, fluoroalkoxy, alkenyl or fluoroalkenyl;
the additive B may be a boron-containing lithium salt.

Through the synergistic effect of the additive A and the additive B, the present disclosure can inhibit the decomposition of the electrolyte solution at high temperature, avoid gas generation, improve the safety, and effectively improve the high-temperature storage performance and cycle performance of the battery.

In the present disclosure, when n=1, the number of C atoms of R₁ may be 1 to 6; when n=2, the number of C atoms of R₁ may be 1 to 3; when n=3, the number of C atoms of R₁ may be 1 or 2.

In the present disclosure, when R₂ and R₃ are selected from groups other than hydrogen and phenyl, the number of C atoms of R₂ and R₃ may be from 2 to 6, respectively.

R₁ may be selected from alkylene, alkyleneoxy, or alkenylene, and R₂ and R₃ may be independently selected from hydrogen, phenyl, alkyl, alkenyl, alkoxy or alkynyloxy.

In the present disclosure, when R₁ is selected from alkylene or alkenylene, R₂ and R₃ may be independently selected from alkoxy or alkynyloxy; when R₁ is alkyleneoxy, R₂ and R₃ may be independently selected from hydrogen, phenyl, alkyl, or alkenyl.

Further, when n=0, R₂ may be alkoxy or alkynyloxy.

Additive A may be selected from the group consisting of propargyl acetate, propargyl propionate, ethyl propiolate, 4-pentyn-1-yl acetate, ethyl 2-pentynoate, ethyl 3-butynoate (CAS No: 53841-07-9), ethyl 2-butynoate, carbonic acid methyl 2-propynyl ester, carbonic acid methyl 2-ethynyl ester, ethyl phenylpropiolate, propargyl propiolate, propargyl methacrylate, propargyl benzoate, and combinations thereof.

The boron-containing lithium salt may be selected from the group consisting of lithium difluoro(oxalate) borate, lithium tetrafluoroborate, lithium bis(oxalate)borate, lithium tetraborate, lithium triphenyl-n-butylborate, trimethylimidazolium tetrafluoroborate, and combinations thereof.

The feeding mass of the additive A may account for 0.01 to 2% of the total mass of the non-aqueous electrolyte solution. In embodiments, the feeding mass of the additive A may account for 0.1 to 1% of the total mass of the non-aqueous electrolyte solution. In embodiments, the feeding mass of the additive A may account for 0.2 to 0.8% of the total mass of the non-aqueous electrolyte solution. The feeding mass of the additive B may account for 0.01 to 2% of the total mass of the non-aqueous electrolyte solution. In embodiments, the feeding mass of the additive B may account for 0.3 to 1.5% of the total mass of the non-aqueous electrolyte solution.

The organic solvent may be a mixture of cyclic ester and chain ester. The volume ratio of the cyclic ester to the chain ester in the organic solvent may be 1:(5 to 15). In embodiments, the volume ratio of the cyclic ester to the chain ester in the organic solvent may be 1:(7 to 12). The cyclic ester may be selected from the group consisting of γ-butyrolactone (GBL), ethylene carbonate (EC), propylene carbonate (PC), fluoroethylene carbonate (FEC), and combinations thereof. In embodiments, the chain ester may be selected from the group consisting of dimethyl carbonate (DMC), ethyl methyl carbonate (EMC), diethyl carbonate (DEC), methyl propyl carbonate (MPC), methyl propionate (MP), ethyl propionate (EP), propyl propionate (PP), methyl acetate (MA), ethyl acetate (EA), propyl acetate (PA), methyl butyrate (MB), ethyl butyrate (EB), propyl butyrate (PB), methyl fluoropropionate (FMP), propyl fluoropropionate, ethyl fluoropropionate, ethyl fluoroacetate, and combinations thereof.

In embodiments, the lithium salt may be selected from the group consisting of lithium hexafluorophosphate (LiPF₆), lithium tetrafluoroborate (LiBF₄), lithium hexafluoroarsenate (LiAsF₆), anhydrous lithium perchlorate (LiClO₄), lithium bis(trifluoromethanesulfonyl)imide (LiN(SO₂CF₃)₂), lithium difluorobis(oxalate)phosphate (LiPF₂(C₂O₄)₂), lithium difluorophosphate (LiPO₂F₂), lithium trifluoromethanesulfonate (LiSO₃CF₃), lithium difluorobisoxalate phosphate (LiPO₈C₄F₂), lithium oxalyldifluoroborate, lithium bis(fluorosulfonyl)imide (LiN(SO₂F)₂), and combinations thereof.

The concentration of the lithium salt may be from 1 to 1.5 mol/L. In embodiments, the concentration of the lithium salt may be from 1.1 to 1.3 mol/L.

The additives may further comprise other additives, and the other additives may be selected from the group consisting of vinylene carbonate (VC), vinyl ethylene carbonate (VEC), biphenyl (BP), cyclohexylbenzene (CHB), trioctyl phosphate (TOP), fluoroethylene carbonate (FEC), succinonitrile (SN), adiponitrile (AND), 1,3,6-hexanetricarbonitrile (HTCN), and combinations thereof.

The feeding mass of the other additives may account for 2 to 10% of the total mass of the non-aqueous electrolyte solution, such as 5 to 8%.

The other additives may be vinylene carbonate and vinyl ethylene carbonate with a mass ratio of 1:(1.5 to 4). In embodiments, the other additives may be vinylene carbonate and vinyl ethylene carbonate with a mass ratio of 1:(2 to 3).

Another purpose of the present disclosure is to provide a lithium battery comprising a positive electrode, a negative electrode and an electrolyte solution, and the electrolyte solution is the non-aqueous electrolyte solution.

In the present disclosure, the additive A having the above-mentioned structure and the additive B may be simultaneously contained in the non-aqueous electrolyte solution, and may be coordinated with other components of the electrolyte solution, so that the lithium-ion battery containing the electrolyte solution has good high-temperature and cycle performance.

Due to the use of the above technical solutions, the present disclosure may have the following advantages over the prior art:

In the non-aqueous electrolyte solution of the present disclosure, a new additive capable of replacing a sulfur-containing compound may be used (e.g. no sulphur containing compound is present), such that the high-temperature storage performance and cycle performance of a lithium battery can be improved, and more options for the preparation of non-aqueous electrolyte solutions and lithium batteries are provided.

### DETAILED DESCRIPTION

In the following, the present disclosure is further described combining with specific embodiments. However, the present disclosure is not limited to these embodiments. The implementation conditions employed by the embodiments may be further adjusted according to particular requirements, and undefined implementation conditions usually are conditions in conventional experiments. The technical features involved in the respective implementations of the present disclosure can be combined with each other if they do not conflict with each other.

Unless otherwise specified, in the following embodiments and comparative examples, ppm refers to the concentration in parts per million, and wt % refers to the percentage by weight.

### Embodiment 1

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propynyl acetate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 2

In an argon-filled glove box (H₂O content<10 ppm), DEC, EC and EMC were uniformly mixed at a volume ratio of 3:1:6, and 1.2 mol/L LiPF₆ was added to the mixed solution, then 0.5 wt % propynyl acetate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 3

In an argon-filled glove box (H₂O content<10 ppm), DEC, EC and EMC were uniformly mixed at a volume ratio of 3:1:6, and 1.2 mol/L LiPF₆ was added to the mixed solution, then 1 wt % propynyl acetate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 4

In an argon-filled glove box (H₂O content<10 ppm), DEC, EC and EMC were uniformly mixed at a volume ratio of 3:1:6, and 1.2 mol/L LiPF₆ was added to the mixed solution, then 1 wt % propynyl acetate, 0.3 wt % lithium difluoro(oxalate) borate, 2 wt % vinylene carbonate and 5 wt % vinyl ethylene carbonate were respectively added to the mixed solution to give an electrolyte solution.

### Embodiment 5

In an argon-filled glove box (H₂O content<10 ppm), DEC, EC and EMC were uniformly mixed at a volume ratio of 3:1:6, and 1.2 mol/L LiPF₆ was added to the mixed solution, then 1 wt % propynyl acetate, 1 wt % lithium difluoro(oxalate) borate, 2 wt % vinylene carbonate, and 5 wt % vinyl ethylene carbonate were respectively added to the mixed solution to give an electrolyte solution.

### Embodiment 6

In an argon-filled glove box (H₂O content<10 ppm), DEC, EC and EMC were uniformly mixed at a volume ratio of 3:1:6, and 1.2 mol/L LiPF₆ was added to the mixed solution, then 1 wt % propynyl acetate, 1.5 wt % lithium difluoro(oxalate) borate, 2 wt % vinylene carbonate, and 5 wt % vinyl ethylene carbonate were respectively added to the mixed solution to give an electrolyte solution.

### Embodiment 7

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % ethyl propiolate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 8

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % carbonic acid methyl 2-propynyl ester, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 9

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % ethyl phenylpropiolate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 10

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl propiolate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 11

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl methacrylate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 12

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl benzoate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 13

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl propionate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 14

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % 4-pentyn-1-yl acetate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 15

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % ethyl 2-pentynoate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 16

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % ethyl 3-butynoate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 17

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % ethyl 2-butynoate, 0.5 wt % lithium difluoro(oxalate) borate, 2 wt % vinylene carbonate, and 5 wt % vinyl ethylene carbonate were respectively added to the mixed solution to give an electrolyte solution.

### Embodiment 18

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propynyl acetate, 0.5 wt % lithium tetrafluoroborate, 2 wt % vinylene carbonate, and 5 wt % vinyl ethylene carbonate were respectively added to the mixed solution to give an electrolyte solution.

### Embodiment 19

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propynyl acetate, 0.5 wt % lithium triphenyl-n-butylborate, 2 wt % vinylene carbonate, and 5 wt % vinyl ethylene carbonate were respectively added to the mixed solution to give an electrolyte solution.

### Embodiment 20

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propynyl acetate, 0.5 wt % trimethylimidazolium tetrafluoroborate, 2 wt % vinylene carbonate, and 5 wt % vinyl ethylene carbonate were respectively added to the mixed solution to give an electrolyte solution.

### Embodiment 21

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl benzoate and 0.5 wt % lithium difluoro(oxalate) borate were respectively added to the mixed solution to give an electrolyte solution.

### Embodiment 22

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % carbonic acid methyl 2-propynyl ester and 0.5 wt % lithium difluoro(oxalate) borate were respectively added to the mixed solution to give an electrolyte solution.

### Embodiment 23

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl acetate and 0.5 wt % lithium difluoro(oxalate) borate were respectively added to the mixed solution to give an electrolyte solution.

### Comparative Example 1

In an argon-filled glove box (H₂O content<10 ppm), DEC, EC and EMC were uniformly mixed at a volume ratio of 3:1:6, and 1.2 mol/L LiPF₆ was added to the mixed solution, then 2 wt % vinylene carbonate, and 5 wt % vinyl ethylene carbonate were respectively added to the mixed solution to give an electrolyte solution.

### Comparative Example 2

In an argon-filled glove box (H₂O content<10 ppm), DEC, EC and EMC were uniformly mixed at a volume ratio of 3:1:6, and 1.2 mol/L LiPF₆ was added to the mixed solution, then 0.5 wt % lithium difluoro(oxalate) borate, 2 wt % vinylene carbonate, and 5 wt % vinyl ethylene carbonate were respectively added to the mixed solution to give an electrolyte solution.

### Comparative Example 3

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propynyl acetate, 2 wt % vinylene carbonate, and 5 wt % vinyl ethylene carbonate were respectively added to the mixed solution to give an electrolyte solution.

### Comparative Example 4

In an argon-filled glove box (H₂O content<10 ppm), DEC, EC and EMC were uniformly mixed at a volume ratio of 3:1:6, and 1.2 mol/L LiPF₆ was added to the mixed solution, then 1.5 wt % 1,3-propanesultone, 2 wt % vinylene carbonate, and 5 wt % vinyl ethylene carbonate were respectively added to the mixed solution to give an electrolyte solution.

### Comparative Example 5

In an argon-filled glove box (H₂O content<10 ppm), DEC, EC and EMC were uniformly mixed at a volume ratio of 3:1:6, and 1.2 mol/L LiPF₆ was added to the mixed solution, then 0.3 wt % propargyl acetate was added to the mixed solution to give an electrolyte solution.

### Comparative Example 6

In an argon-filled glove box (H₂O content<10 ppm), DEC, EC and EMC were uniformly mixed at a volume ratio of 3:1:6, and 1.2 mol/L LiPF₆ was added to the mixed solution, then 0.5 wt % lithium difluoro(oxalate) borate was added to the mixed solution to give an electrolyte solution.

The electrolyte solutions prepared from the above-mentioned Embodiments 1 to 23 and Comparative Examples 1 to 6 were tested in the MCN811 graphite battery respectively:
The capacity retention rate after 30 days of high-temperature storage at 60° C., i.e., the capacity when discharging to 3.0 V at 1 C after charging to 4.2 V at 1 C under constant current/constant voltage (CC/CV) conditions at 25° C. and then storing in an oven at 60° C. for 30 days divided by the capacity when discharging to 3.0 V at 1 C after charging under the same conditions without storage;
The battery bulging rate stored at a high temperature of 60° C. for 30 days, that is, the difference between the thickness of the battery after storage and the thickness of the battery before storage divided by the thickness of the battery before storage;
The capacity retention rate after 1000 cycles at 45° C., i.e., the capacity when discharging to 3.0 V at 1 C after charging to 4.2 V at 1 C under constant current/constant voltage (CC/CV) conditions at 45° C. after 1000 cycles at 45° C. divided by the capacity when discharging to 3.0 V at 1 C after charging to 4.2 V under the same conditions without cycles;
The battery bulging rate after 1000 cycles at 45° C., that is, the difference between the thickness of the battery after the cycles and the thickness of the battery before the cycles divided by the thickness of the battery before the cycles;
The relevant experimental data are shown in Table 1.

TABLE 1

| | Capacity retention | Battery bulging | | |
|---|---|---|---|---|
| | rate after 30 days | rate after 30 days | | |
| | of high- | of high- | Battery capacity | Battery capacity |
| | temperature | temperature | retention rate | bulging rate |
| | storage at 60° C. | storage at 60° C. | after 1000 cycles | after 1000 cycles |
| | (%) | (%) | at 45° C. (%) | at 45° C. (%) |
| Embodiment | 90.5 | 9.2 | 88.9 | 4.5 |
| 1 | | | | |
| Embodiment | 90.1 | 9.1 | 88.7 | 4.3 |
| 2 | | | | |
| Embodiment | 89.6 | 9.1 | 88.8 | 4.4 |
| 3 | | | | |
| Embodiment | 90.2 | 9.0 | 87.9 | 4.5 |
| 4 | | | | |
| Embodiment | 90.3 | 9.1 | 89.6 | 4.4 |
| 5 | | | | |
| Embodiment | 89.8 | 9.0 | 88.7 | 4.5 |
| 6 | | | | |
| Embodiment | 89.5 | 9.3 | 86.5 | 4.3 |
| 7 | | | | |
| Embodiment | 89.2 | 9.0 | 86.7 | 4.2 |
| 8 | | | | |
| Embodiment | 88.5 | 8.7 | 88.2 | 3.9 |
| 9 | | | | |
| Embodiment | 90.9 | 8.2 | 89.3 | 3.8 |
| 10 | | | | |
| Embodiment | 89.7 | 9.4 | 89.2 | 4.5 |
| 11 | | | | |
| Embodiment | 89.4 | 8.3 | 89.1 | 3.9 |
| 12 | | | | |
| Embodiment | 88.6 | 8.4 | 88.9 | 4.2 |
| 13 | | | | |
| Embodiment | 88.7 | 8.6 | 88.7 | 4.3 |
| 14 | | | | |
| Embodiment | 88.2 | 8.5 | 89.1 | 4.1 |
| 15 | | | | |
| Embodiment | 88.5 | 8.3 | 88.7 | 4.2 |
| 16 | | | | |
| Embodiment | 89.1 | 8.2 | 59.4 | 4.2 |
| 17 | | | | |
| Embodiment | 89.5 | 9.0 | 88.3 | 4.4 |
| 18 | | | | |
| Embodiment | 88.9 | 8.2 | 87.5 | 3.7 |
| 19 | | | | |
| Embodiment | 89.6 | 8.5 | 89.2 | 3.8 |
| 20 | | | | |
| Embodiment | 87.5 | 9.4 | 86.4 | 4.2 |
| 21 | | | | |
| Embodiment | 88.1 | 9.2 | 85.2 | 4.4 |
| 22 | | | | |
| Embodiment | 89.2 | 9.3 | 86.1 | 4.4 |
| 23 | | | | |
| Comparative | 60.5 | 20.5 | 75.2 | 6.9 |
| example 1 | | | | |
| Comparative | 69.4 | 19.1 | 77.3 | 6.2 |
| example 2 | | | | |
| Comparative | 70.2 | 17.5 | 78.2 | 5.9 |
| example 3 | | | | |
| Comparative | 90.2 | 9.1 | 88.4 | 4.2 |
| example 4 | | | | |
| Comparative | 69.5 | 17.8 | 77.5 | 6.0 |
| example 5 | | | | |
| Comparative | 67.7 | 19.5 | 76.9 | 6.3 |
| example 6 | | | | |

The above detailed describes the present disclosure, and is intended to make those skilled in the art being able to understand the present disclosure and thereby implement it, and should not be concluded to limit the protective scope of this disclosure. Any equivalent variations or modifications according to the spirit of the present disclosure should be covered by the protective scope of the present disclosure.

1. A non-aqueous electrolyte solution, comprising a lithium salt, an organic solvent, and additives, wherein the additives comprise an additive A and an additive B,
the additive A is one or more of the substances represented by the structural general formula (1), the structural general formula (1) of the additive A is: 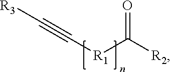
0≤n≤3,
R₁ is selected from alkylene, alkyleneoxy, fluoroalkylene, fluoroalkyleneoxy, alkenylene or fluoroalkenylene, and
R₂ and R₃ are independently selected from hydrogen, phenyl, alkynyl, alkynyloxy, alkyl, alkoxy, fluoroalkyl, fluoroalkoxy, alkenyl or fluoroalkenyl; and
the additive B is a boron-containing lithium salt.

2. The non-aqueous electrolyte solution of claim 1, wherein R₁ is selected from alkylene, alkyleneoxy, or alkenylene, and R₂ and R₃ are independently selected from hydrogen, phenyl, alkyl, alkenyl, alkoxy or alkynyloxy.

3. The non-aqueous electrolyte solution of claim 2, wherein—the additive A is selected from the group consisting of propargyl acetate, propargyl propionate, ethyl propiolate, 4-pentyn-1-yl acetate, ethyl 2-pentynoate, ethyl 3-butynoate, ethyl 2-butynoate, carbonic acid methyl 2-propynyl ester, carbonic acid methyl 2-ethynyl ester, ethyl phenylpropiolate, propargyl propiolate, propargyl methacrylate, propargyl benzoate, and combinations thereof.

4. The non-aqueous electrolyte solution of claim 1, wherein the additive B is selected from the group consisting of lithium difluoro(oxalate) borate, lithium tetrafluoroborate, lithium bis(oxalate)borate, lithium tetraborate, lithium triphenyl-n-butylborate, trimethylimidazolium tetrafluoroborate, and combinations thereof.

5. The non-aqueous electrolyte solution of claim 1, wherein:
a feeding mass of the additive A accounts for 0.01 to 2% of a total mass of the non-aqueous electrolyte solution; and
a feeding mass of the additive B accounts for 0.01 to 2% of the total mass of the non-aqueous electrolyte solution.

6. The non-aqueous electrolyte solution of claim 5, wherein:
the feeding mass of the additive A accounts for 0.1 to 1% of the total mass of the non-aqueous electrolyte solution; and/or
the feeding mass of the additive B accounts for 0.3 to 1.5% of the total mass of the non-aqueous electrolyte solution.

7. The non-aqueous electrolyte solution of claim 1, wherein the organic solvent is a mixture of cyclic ester and chain ester.

8. The non-aqueous electrolyte solution of claim 7, wherein the cyclic ester is selected from the group consisting of γ-butyrolactone, ethylene carbonate, propylene carbonate, fluoroethylene carbonate, and combinations thereof; and/or
the chain ester is selected from the group consisting of dimethyl carbonate, ethyl methyl carbonate, diethyl carbonate, methyl propyl carbonate, methyl propionate, ethyl propionate, propyl propionate, methyl acetate, ethyl acetate, propyl acetate, methyl butyrate, ethyl butyrate, propyl butyrate, methyl fluoropropionate, propyl fluoropropionate, ethyl fluoropropionate, ethyl fluoroacetate, and combinations thereof.

9. The non-aqueous electrolyte solution to of claim 1, wherein the lithium salt is selected from the group consisting of lithium hexafluorophosphate, lithium tetrafluoroborate, lithium hexafluoroarsenate, anhydrous lithium perchlorate, lithium bis(trifluoromethanesulfonyl)imide, lithium difluorobis(oxalate)phosphate, lithium difluorophosphate, lithium trifluoromethanesulfonate, lithium difluorobisoxalate phosphate, lithium oxalyldifluoroborate, lithium bis(fluorosulfonyl)imide, and combinations thereof.

10. The non-aqueous electrolyte solution of claim 9, wherein a concentration of the lithium salt is 1 to 1.5 mol/L.

11. The non-aqueous electrolyte solution of claim 1, wherein the additives further comprise other additives selected from the group consisting of vinylene carbonate, vinyl ethylene carbonate, biphenyl, cyclohexylbenzene, trioctyl phosphate, fluoroethylene carbonate, succinonitrile, adiponitrile, 1,3,6-hexanetricarbonitrile, and combinations thereof.

12. The non-aqueous electrolyte solution of claim 11, wherein the other additives are vinylene carbonate and vinyl ethylene carbonate with a mass ratio of from 1:1.5 to 1:4.

13. A non-aqueous electrolyte solution, comprising a lithium salt, an organic solvent, and additives, wherein the additives comprise an additive A and an additive B,
the additive A is selected from the group consisting of propargyl acetate, propargyl propionate, ethyl propiolate, 4-pentyn-1-yl acetate, ethyl 2-pentynoate, ethyl 3-butynoate, ethyl 2-butynoate, carbonic acid methyl 2-propynyl ester, carbonic acid methyl 2-ethynyl ester, ethyl phenylpropiolate, propargyl propiolate, propargyl methacrylate, propargyl benzoate, and combinations thereof, wherein a feeding mass of the additive A accounts for 0.01 to 2% of the total mass of the non-aqueous electrolyte solution;
the additive B is selected from the group consisting of lithium difluoro(oxalate) borate, lithium tetrafluoroborate, lithium bis(oxalate)borate, lithium tetraborate, lithium triphenyl-n-butylborate, trimethylimidazolium tetrafluoroborate, and combinations thereof, wherein the feeding mass of the additive B accounts for 0.01 to 2% of the total mass of the non-aqueous electrolyte solution;
the lithium salt is selected from the group consisting of lithium hexafluorophosphate, lithium tetrafluoroborate, lithium hexafluoroarsenate, anhydrous lithium perchlorate, lithium bis(trifluoromethanesulfonyl)imide, lithium difluorobis(oxalate)phosphate, lithium difluorophosphate, lithium trifluoromethanesulfonate, lithium difluorobisoxalate phosphate, lithium oxalyldifluoroborate, lithium bis(fluorosulfonyl)imide, and combinations thereof, wherein the concentration of the lithium salt is 1 to 1.5 mol/L; and
the organic solvent is a mixture of cyclic ester and chain ester, the cyclic ester is selected from the group consisting of γ-butyrolactone, ethylene carbonate, propylene carbonate, fluoroethylene carbonate, and combinations thereof; the chain ester is selected from the group consisting of dimethyl carbonate, ethyl methyl carbonate, diethyl carbonate, methyl propyl carbonate, methyl propionate, ethyl propionate, propyl propionate, methyl acetate, ethyl acetate, propyl acetate, methyl butyrate, ethyl butyrate, propyl butyrate, methyl fluoropropionate, propyl fluoropropionate, ethyl fluoropropionate, ethyl fluoroacetate, and combinations thereof, and the volume ratio of the cyclic ester to the chain ester in the organic solvent is from 1:5 to 1:15.

14. The non-aqueous electrolyte solution of claim 13, wherein the additives further comprise other additives selected from the group consisting of vinylene carbonate, vinyl ethylene carbonate, biphenyl, cyclohexylbenzene, trioctyl phosphate, fluoroethylene carbonate, succinonitrile, adiponitrile, 1,3,6-hexanetricarbonitrile, and combinations thereof, wherein the feeding mass of the other additives accounts for 2 to 10% of the total mass of the non-aqueous electrolyte solution.

15. A lithium battery, comprising a positive electrode, a negative electrode, and the non-aqueous electrolyte solution of claim 1.

16. The non-aqueous electrolyte solution of claim 1, wherein the additives do not comprise sulfur-containing compounds.
